(19) United States
(12) Patent Application Publication
(10) Pub. No.: US 2007/0083592 A1
(43) Pub. Date: Apr. 12, 2007

(54) System and method for distributing shared storage for collaboration across multiple devices

(76) Inventors: Linda Ruth Bartram, Vancouver (CA); Michael Anthoy Blackstock, Coquitiam (CA); Henk Gerardus Maris Spaay, North Vancouver (CA)

Correspondence Address: THELEN REID BROWN RAYSMAN & STEINER LLP, P.O. BOX 640640, SAN JOSE, CA, 95164-0640, US

(21) Appl. No.: 11/524,613

(22) Filed: Sep. 20, 2006

Related U.S. Application Data
(63) Continuation of application No. 10/205,916, filed on Jul. 25, 2002, now abandoned.

(51) Int. Cl. G06F 15/16

(52) U.S. Cl. 709/204

(57) ABSTRACT

A method and apparatus is described in which anchors are used to produce a shared store display. The anchors are pointers to objects which are distributively stored on a peer-to-peer network. Not all of the objects are copied to each of the units in the peer-to-peer network. Additionally, not all of the objects are stored in a central server. The peer-to-peer network software allows for collaborative networking of the objects in the shared store.

The present invention relates to collaborative network systems. Collaborative network systems consist of any number of computing devices, fixed location or portable computers, operated by users and linked to each other by wire or wireless networking methods running collaboration application software and infrastructure. Collaborative network systems allow users to interact and operate on a number of objects such as files or database elements. Collaborative network systems can use a shared space. The shared space includes the accessible objects for the members of the collaborative network.

In a standard client-server architecture for a collaborative network, the server stores the objects. The clients can view and manipulate the objects via server access. Since the server stores the shared objects, the user must upload or create an object on the server to make the object available to others. Server systems can enforce version control, synchronization and locking mechanisms to manage file and data integrity.

While server-based collaborative networks work well for fixed network configurations, they do not work as well with more dynamic environments of mobile computing. In mobile computing networks, server access is unpredictable.

Some collaboration systems, such as GROOVE™ or Lotus Notes™, replicate all objects in a shared store at each unit. This results in data proliferation since everyone has a full copy of all objects whether they need them or not. Local storage and bandwidth limitations can make this data proliferation undesirable.

Mobile collaboration typically involves a collection of different devices, from powerful laptops to lightweight personal video assistance (“PDAs”) and even smart phones. Storage mechanisms differ by device. Laptops use hard disks, where PDAs store data only in random access memory (“RAM”). Processing power and bandwidth also vary. The full local replication approach is not efficient for mobile collaboration, since it loads the devices on a network down with more traffic and files than their efficient storage capacity. Additionally, the connectivity of the collaborative network can be sporadic. People can join and leave the collaborative network at different times. Supporting a variety of devices also introduces issues of optimal file and storage capacity, as well as transfer capacity.

### SUMMARY OF THE PRESENT INVENTION

An exemplary embodiment of the present invention relates to a collaborative network in a peer-to-peer configuration comprising units operably connected, with the units having software to produce a shared store display indicating objects in a shared store, and the objects in the shared store being available to each of the units in the network. For at least one unit, the objects in a shared store include local objects at the unit and remote objects at other units. The software is configured so that remote objects can be copied into a local unit under the user's control. The software is not configured to automatically copy objects at the remote unit.

Another exemplary embodiment of the present invention relates to a method comprising producing a shared store display at a unit indicating objects in a shared store, with the objects in the shared store being available to each of the units in a peer-to-peer network, and the shared store display referencing local objects at the unit and remote objects at other units. The method also includes under user control, copying a remote object referencing the shared store and storing the copy of the object locally at the unit, wherein remote objects in the shared store are not automatically copied and stored locally at the unit.

Yet another exemplary embodiment of the present invention is a method. The method includes producing a shared store display at a unit indicating objects in a shared store. The objects in the shared store being available to each of the units in a peer-to-peer network, the shared store display referencing local objects at the unit and remote objects at the other units. The method also including under user control, reconciling a local object with a remote object referenced in the shared store by deciding how to reconcile conflicts by replacing a local or remote object, or using an application to merge changes appropriately, then removing a local object if desired.

The objects can be shared across a number of units on the peer-to-peer network. In one embodiment, objects are supplied by individual users and reflected at other units in a user interface view dedicated to the shared store using object anchors. In one embodiment, object anchors act like pointers in that they contain the address of the object, not necessarily the object such as a file itself. The object anchors represent the content of the shared store. Users can make a copy of any remote object by selecting the copy operation on the remote object's anchor. Multiple local copies can therefore exist on the shared store and are indicated by the object's owners to others. When a person's local copy needs to be merged or reconciled with another, the version information can be supplied to the appropriate people and the decision of how to synchronize a file content is left to the user's specific application tools. By using anchors rather than objects to continuously exchange an update across the shared store, the bandwidth and local storage requirement for the units in the peer-to-peer network are reduced. Additionally, a large collaborative network with a large shared store can be represented with a very small physical storage capacity, such as those used with PDAs or mobile phones, since not all the objects need to be stored by every peer but only the anchors which point to the objects.

### BRIEF DESCRIPTION OF THE DRAWINGS

FIG. 1 illustrates an example system for distributing shared storage for collaboration across multiple devices.

FIG. 2 illustrates an example of the shared view for the example of FIG. 1.

FIG. 3 illustrates an example of a user interface for use with an embodiment of the present invention.

FIG. 4 illustrates an example method for distributing shared storage for collaboration across multiple devices.

FIG. 5 illustrates an example method for copying a remote object to a storage local to a unit.

### DETAILED DESCRIPTION OF THE INVENTION

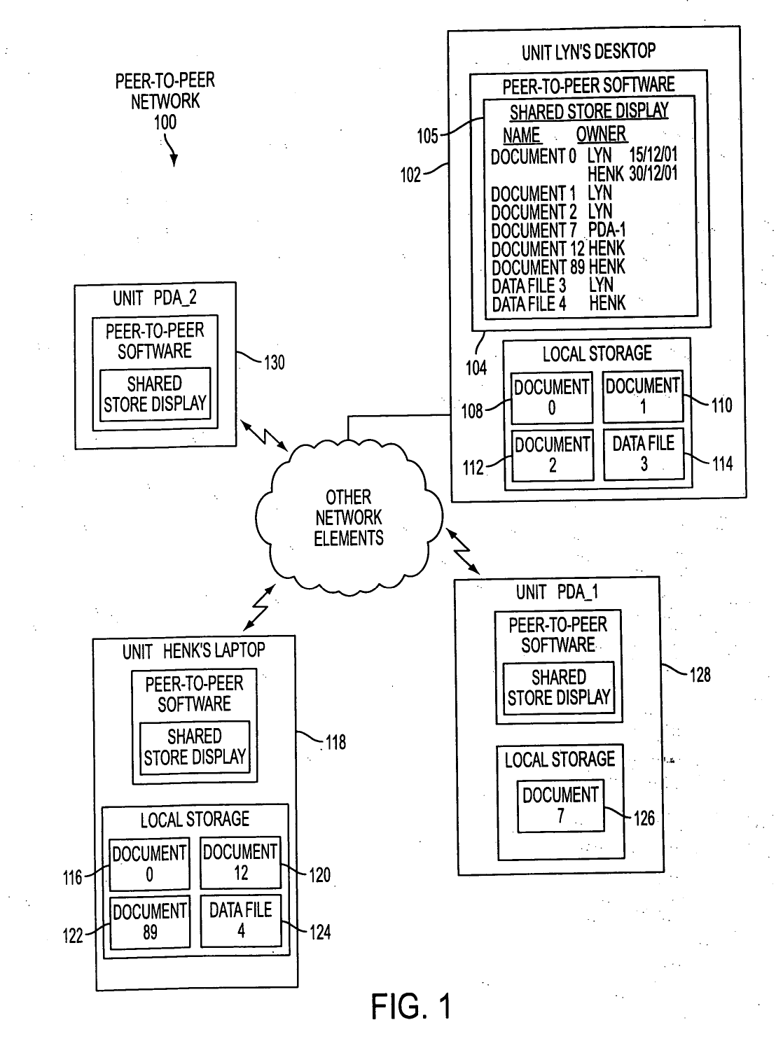

An exemplary embodiment of the present invention comprises a peer-to-peer network, such as the peer-to-peer network 100 of FIG. 1. The peer-to-peer network comprises units operably connected to the peer-to-peer network. In example of FIG. 1, the units include computers 102 and 118 and PDAs 128 and 130. Units that can be connected to the peer-to-peer networks include, in addition to desktop and PDAs, mobile phones, laptops, servers, and any other electronic devices. The units have software, such as the collaborative software 104 of FIG. 1, to produce a shared store display, such as the shared store display 105 of FIG. 1. The shared store display indicates objects in the shared store that are accessible to the local user. The objects for the shared store can include files and any other data objects. In one example, all objects are transparently represented using object anchors: that is, the shared store contains a list of anchors, and not necessarily the objects themselves.

For at least one unit, the objects of the shared store include local objects at the unit and remote objects at other units. In the example of FIG. 1, the shared store includes the local objects “document 0” 108, “document 1” 110, “document 2” 112, and “data file 3” 114. Objects which are remote to the unit 102 include a “document 12” 120, “document 89” 142, “data file 4” 124 and a version of “document 0” 116 at unit 118, as well as “document 7” 126 stored at unit 128.

Since the shared store display can show indications of both local documents and remote documents, not all of the objects need to be loaded or stored locally to the unit. This can reduce the storage requirement and bandwidth transfer requirement for the units of the peer-to-peer network.

In an exemplary embodiment, the software is configured such that remote objects can be copied and stored locally at the unit under user control but the software is not configured to automatically copy and store the objects at the unit.

In the example of FIG. 1, a user of unit 118 can look at the shared store display and see that “document 0” is a remote object to unit 118. The user of unit 118, in this case, Henk, can select “document 0”. This selection can cause a request to be sent to the unit 102 to cause the “document 0” to be copied across the network to the unit 118. When an object is copied, the shared store display 105 can indicate the copies of the object at different units of the network. For example, there are two copies of “document 0” which are available objects: one created by Lyn on Dec. 15, 2001 and the other created by Henk on Dec. 30, 2001.

In an exemplary embodiment, the peer-to-peer network is a collaborative peer-to-peer network. An exemplary embodiment of the present invention is a method. The method comprises producing a shared store display, such as shared store display 105 of FIG. 1. The shared store display at a unit indicates objects in a shared store. The objects in the shared store are available to each of the units in the peer-to-peer network. The shared store display references local objects at the unit and remote objects of other units. The method also includes, under user control, copying a remote object referenced in the shared store and sharing a copy of that object locally at the unit, wherein remote objects in the shared store are not automatically copied and stored locally at the unit.

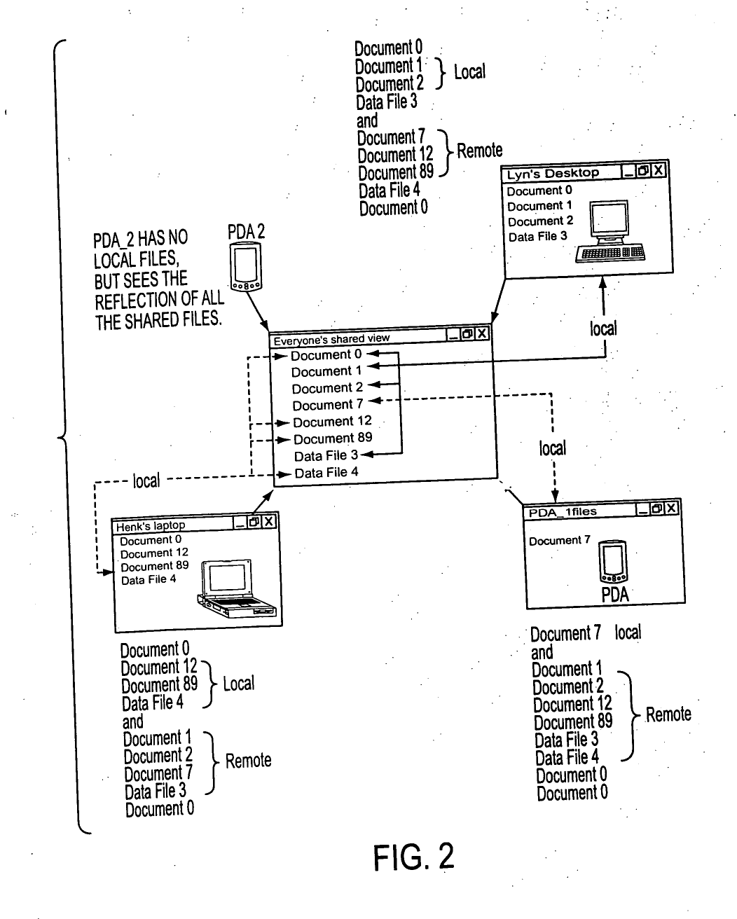

FIG. 2 illustrates an example of the shared view for the example of FIG. 1. Most of the units include both local and remote objects in the shared store. In this example, everyone's shared view includes all of the objects. In the example of FIG. 2, “document 0” has two versions: a first version local at Lyn's desktop and the second version local to Henk's laptop. Even though everyone has the same shared view, different objects will be local or remote to different units.

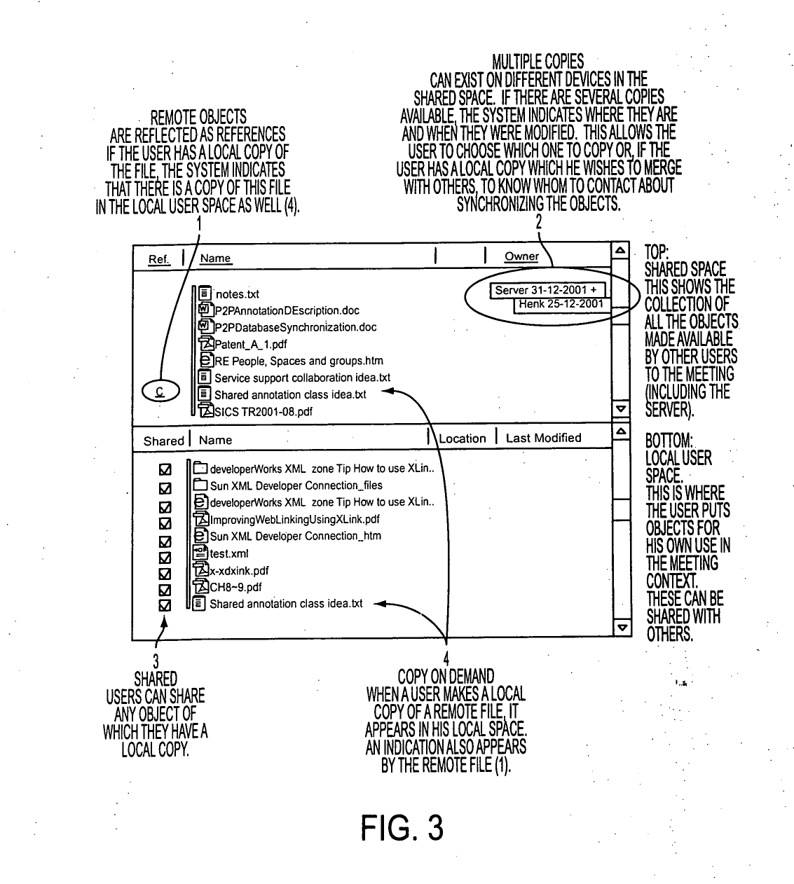

FIG. 3 illustrates an example of a user interface for use with the system in the present invention. The user interface of this example includes a shared space which stores all of the objects made available by other users to the meeting.

The user interface of this example also includes a local user space. The local user space is a space containing anchors to objects that the user holds on his or her own device for his or her own use in the meeting context. These local objects may be shared with others in the peer-to-peer network or may be kept private until such time as the user chooses to share them. In the example of FIG. 3, the remote objects of which there is a copy in the local user space are indicated by the letter “C”. In the example of FIG. 3, multiple copies can exist on different devices in the shared space. If several copies are available, the system indicates where the versions are and when they were modified. This allows the user to choose which version to copy or, if the user has a local copy which he wishes to merge with the others, to determine who to contact about synchronizing the objects. In the example of FIG. 3, the user can check on a shared box to indicate which local object to share.

For the example of FIG. 3, the file “shared annotation class idea.txt” has two versions in the shared store. A first version is local to the unit, and a second version is remote to the unit.

In one embodiment, the peer-to-peer software 104 uses anchors to reference the objects. An object can be referenced by an anchor. The anchors have information that can include name information, location information, owner information and modification and history information. The anchors also can be used to reference the objects in a local storage. The peer-to-peer software 104 can also include collaboration software that allows for the object in the shared storage to be operated on in a collaborative manner.

In one example, anchors to objects are represented in the shared store of the collaborative network on each device. Anchors are not created or deleted directly by the user. The anchors reflect objects from two types of sources: local and remote. When a user tags an object as belonging to the local user space, an anchor is created to the local object, although the anchor is not distributed to other users on the collaborative network. When a user tags a local object in the local user space as shared, its anchor information is distributed to other users on the network and appears in their shared store views as an anchor to a remote object.

If the holder of a local file unshares a file, then its anchor will be removed from the other units use, and from the context of the shared store. When a unit is connected to the peer-to-peer network, the unit's view of the shared space is synchronized with the units on the peer-to-peer network. If the files have been added or removed from the set of shared objects by the unit, these changes will be reflected on all other units of the peer-to-peer network. In one embodiment, a user can replicate any remote file by selecting it. This can be done by selecting the object's anchor and using a local copy operation. For example, in the example of FIG. 3, by clicking on the anchor for the “shared annotation class idea.txt” object, local object copy of this remote object is produced. In one embodiment, the anchor points to object entrances and not to object types, and there are two anchors reflecting two copies of an object from a common root. In one embodiment, a tracking mechanism detects the change history and updates the anchors appropriately with modification and ownership attributes. The user interface of the shared store may combine these anchors into a composite representation as shown in FIG. 3 with respect to the object anchor “notes.txt”.

In one embodiment, the user can determine that several versions of the file exist, and can find out who has the versions and who has the latest version. In this way, users can determine among themselves how to reconcile conflicts and merge changes. In one example, existing tools for the object applications, such as a word processing program, can be used to reconcile the conflicts by merging the changes.

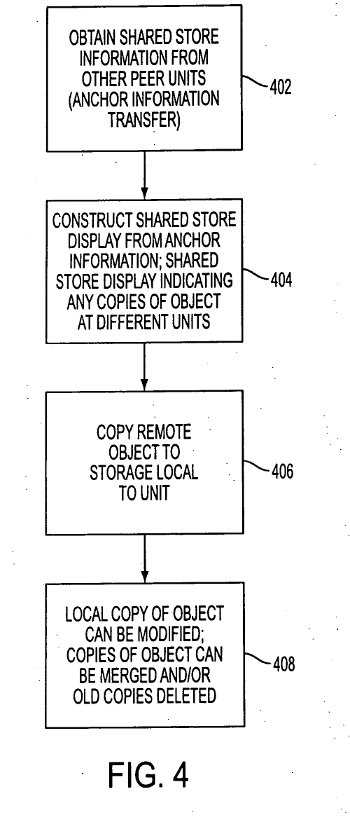

FIG. 4 illustrates a flow chart of one embodiment of the present invention. In step 402, shared store information is obtained from other peer units. In one example, when a unit enters the peer-to-peer network, the anchor information is transferred among the units so that the shared store display can be produced. In step 404, a shared store display is constructed using the anchor information. The shared store display indicates any copies of an object at the different units. In step 406, a user copies a remote object to a storage local to the unit. In step 408, the user modifies the local version of the object. Copies of the object can be merged and/or old copies deleted.

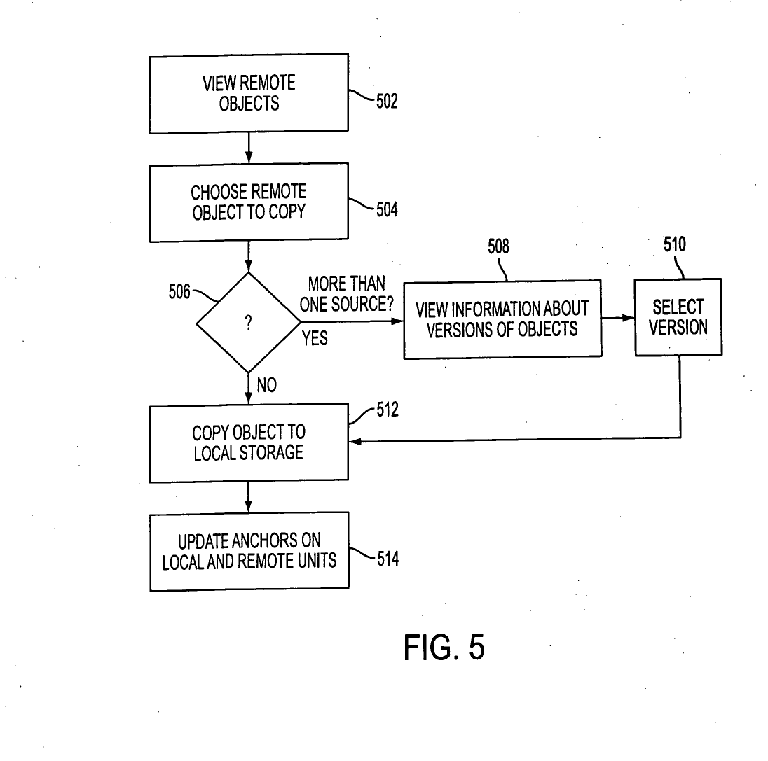

FIG. 5 is a flow chart that illustrates the operation of the copy operation of one embodiment. In step 502, the remote objects are viewed, preferably using the shared store display. In step 504, a remote object is instructed to copy. In step 506, it is checked to see whether there is more than one source for the remote object. If there is, then information is used to browse the different versions of the object in step 508. Instep 510, aversion of the object is selected. After step 510, or if there is not more than one source, in step 512 the object is copied to local storage. In step 514 the anchors are updated on the local and remote units.

An exemplary embodiment of the present invention is a method. The method includes producing a shared store display at a unit indicating objects in a shared store. The objects in the shared store being available to each of the units in a peer-to-peer network, the shared store display referencing local objects at the unit and remote objects at the other units. The method also including under user control, reconciling a local object with a remote object referenced in the shared store by deciding how to reconcile conflicts by replacing a local or remote object, or using an application to merge changes appropriately, then removing a local object if desired.

In one embodiment, before the reconciliation step, the remote object is copied to produce the local object. In one embodiment, after the copying step and before the before the reconciliation step, the local object is modified.

An exemplary embodiment of the present invention is a computer-readable medium containing a program which executes a procedure. The procedure including producing a shared store display at a unit indicating objects in a shared store. The objects in the shared store are available to each of the units in a peer-to-peer network. The shared store display references local objects at the unit and remote objects at the other units. The procedure including, under user control, reconciling a local object with a remote object referenced in the shared store by deciding how to reconcile conflicts by replacing a local or remote object, or using an application to merge changes appropriately, then removing a local object if desired.

Use Cases

This section describes some scenarios and use cases for one embodiment of a shared store system. These use cases describe adding, removing, sharing and reconciliation of different kinds of information. All users are assumed to have a unit, such as desktop, laptop or handheld PDA, capable of wired or wireless connectivity.

Adding Documents and URLs

This use case shows different ways of adding files to the shared store of a collaborative meeting.

Henk, Lyn and Mike use collaboration software to create a new meeting with an associated shared store.

Henk opens Windows Explorer and drags a file from his “My Documents” folder to the shared store. This will copy the document to the location where the shared store physically stores its files, create an anchor to the file and tag it as shared. Henk's shared store now shows that it contains one object, the document he just dragged in.

Lyn remembers a cool web site she likes others to have, so she starts Internet Explorer, locates the web site and copies the universal resource locator (URL) onto the clipboard, and then pastes it in the store of her meeting. The collaborative software creates an anchor to the URL object and tags it as shared. Lyn's store now shows that it contains one object, the URL she just pasted. The URL can be recognized by its anchor's icon as being a URL.

Mike has a Tech Strategy document in his Research folder, which he wants to add to the shared store. He does not want to make a copy though since he is still working on the document and likes to share the latest and greatest version. Similar to using Windows Explorer, he drags the document with the right mouse button and drops it in the shared store. A submenu pops up asking him to either copy or create a shortcut to the document. Mike chooses to create a shortcut. The collaborative software creates an anchor the shortcut and tags it as shared. Mike's store now shows one object, a shortcut to the document. Alternatively, Mike could have chosen File Add from the menu and added the document from the Windows file selection dialog.

Removing Documents

This use case shows how people can remove documents and URLs from the shared store.

Mike has an old document in the shared store, which he wants to remove. He selects the icon for the document and deletes it using a context menu or the delete button. The anchor will be removed from that location in the store. Any anchors from other locations to that specific document will be removed as well.

If the deleted document is a shortcut then only the shortcut is removed and the document remains unaffected.

Henk removes a document but this document has shortcuts to it from several locations. Removing the document would imply that those shortcuts become invalid. The shared store software detects these shortcuts and presents Henk with options: Remove the document, remove the document including all the shortcuts, or leave the document.

Lyn has an old version of Mike's document as well. She runs into it when browsing around the folders using Windows Explorer. She deletes the document. The shared store discovers that the document does not longer exist, and removes it from the list of local files. Any anchors to this document are removed as well. The automatic removal can be preceded by an informational message to the operator about the missing document and ask for confirmation before removing the anchors as well, to account for the case where the original document was moved rather than deleted.

Sharing Documents

This use case shows how people can share documents when in the office or on the move.

Mike creates a new Research presentation in the shared store and marks it as shared. Mike meets with Lyn. This meeting can occur face to face or through the Internet. Lyn's shared store shows the presentation that Mike has marked as shared. Lyn selects the discovered document and instructs the store to make a local copy. Then Lyn marks that copy as shared as well.

The presentation now appears to others as having two copies—one by Lyn and one by Mike.

Henk arrives. He discovers the two versions and sees that they are identical. He copies the presentation from Mike to his computer (original reference) since he has a faster network connection with Mike. He also shares his copy. To others, the file now appears to have 3 copies, all having the same version.

There can be as many copies as people sharing out. Sharing out a copy is optional. If there are links to this document then the user will be warned that these links exist. If the document is deleted then this copy will be removed from the list of documents of all connected users as well.

Working with Different Versions of Documents

This use case describes how people handle different versions of the same documents. Mike creates a new project plan, marks it as shared and meets with Lyn. Lyn discovers the project plan, copies it locally and marks it as shared. Mike takes off to another meeting.

Next, Lyn meets with Henk. Henk discovers the project plan and makes a local copy. They discuss the timeline and Henk changes the timeline by doubling the effort required for the project. Lyn has to run and leaves.

The following day Lyn, Mike and Henk meet again. Henk marks his copy of the project plan as shared. Mike, having the original copy of the project plan, now discovers two other copies: one from Lyn, and one from Henk.

Lyn's version shows the original author and modification date so Mike can see it is unchanged.

Henk's version shows a newer date and author (e.g., Henk). Mike and Lyn decide to copy Henk's version, replacing their own.

A version control system can automatically archive the original version before replacing it with the newer version.

Changing and Reconciling Documents

This use case shows how people modify and reconcile documents when on the move. Mike, Lyn and Henk each have a copy of the same document. Both Henk and Lyn make changes to their copy of the document and each saves it locally on their computer. Lyn is finished and wants to get rid of her version of the document since she is done with it. Before she can delete it however she has to reconcile her changes with someone else. Lyn requests a list of other available copies of the original document. The user interface presents the list of users who have copies (Mike, Henk). Lyn chooses Henk to reconcile with. The system now detects there is a conflict with Henk's version of the document since both have changed from their original copy, and presents Lyn and Henk with options:

a) Create a new different file

b) Lose changes from Henk

c) Lose changes from Lyn

d) Use the application (e.g. Word) to merge changes by Hank

e) Use the application (e.g. Word) to merge changes by Lyn

Lyn and Henk agree on option d). Lyn's copy is sent to Henk's computer where Word is started to merge the two versions. Lyn can now delete her copy of the document. By choice she then only retains a reference to the file—only an anchor pointing to the file on Henk's machine. This will remove her copy from the “copy list” on Henk's and Mike's computer.

Importing and Exhorting the Shared Store

This use case shows how people can use export and import for backup and sharing Lyn plans to upgrade her PC from Windows 2000 to Windows XP. From previous experience she knows that this is a risky process so she decides to backup all her meetings first. She uses the export function to write the important meetings to a network folder. Just to be safe she also exports it to floppy disk. The export function allows her to backup the meeting context, consisting of the meeting definition and the objects in the meetings shared store.

Lyn made a good decision. The installation process crashed and she had to reformat her hard disk. After the lengthy installation process everything except her network adaptor is working again. She imports the meeting context from floppy and can start working again. Mike, having only an old copy from Lyn's tech strategy, asks her for the latest version. Since Lyn's network adapter isn't working he cannot use the network to make a local copy of the document. Fortunately, Lyn still had exported her research meeting to floppy so she hands it to Mike. Mike imports the meeting on floppy and with it comes the latest and greatest tech strategy document.

Additional modifications and improvements of the present invention may also be apparent to those of ordinary skill in the art. The particular example described and illustrated herein, is intended to represent only certain embodiments of the present invention, and is not intended to serve as limitations of alternative devices within the spirit and scope of the invention.

1. A peer-to-peer collaborative network comprising:
units operably connected to the peer-to-peer network, the units having software to produce a shared store display indicating objects in a shared store, the objects in the shared store being available to each of the units in the peer-to-peer network, wherein, for at least one unit, the objects in the shared store include local projects at the unit and remote objects at other units, wherein the software is configured such that remote objects can be copied and stored locally at the unit under user control, the software is not configured to automatically copy and store remote objects at the unit.

2. The peer-to-peer collaborative network of claim 1 wherein the shared store display indicates copies of an object at different units in the network.

3. The peer-to-peer collaborative network of claim 1 wherein the peer-to-peer collaborative network is run on a physical network.

4. The peer-to-peer collaborative network of claim 1 wherein anchors are used to produce the shared store display.

5. The peer-to-peer network of claim 4 wherein the anchors indicate the name and location of the objects in the shared store.

6. The peer-to-peer network of claim 5 wherein the anchors reference a modification history for the objects as well.

7. A method comprising:
producing a shared store display at a unit indicating objects in a shared store, the objects in the shared store being available to each of the units in a peer-to-peer network, the shared store display referencing local objects at the unit and remote objects at the other units; and
under user control, copying a remote object referenced in the shared store and storing the copy of the object locally at the unit, wherein remote objects in the shared store are not automatically copied and stored locally at the unit.

8. The method of claim 7 wherein the shared store display indicates copies of an object at different units of the network.

9. The method of claim 7 wherein the peer-to-peer network is a collaborative network.

10. The method of claim 7 wherein the peer-to-peer network run on a physical network.

11. The method of claim 7 wherein anchors are used to produce the shared store display.

12. The method of claim 11 wherein the anchors reference the name and location of the objects.

13. The method of claim 12 wherein the anchors reference a modification history for the objects.

14. A computer-readable medium containing a program which executes the following procedure:
producing a shared store display at a unit indicating objects in a shared store, the objects in the shared store being available to each of the units in a peer-to-peer network, the shared store display referencing local objects at the unit and remote objects at the other units; and
under user control, copying a remote object referenced in the shared store and storing the copy of the object locally at the unit, wherein remote objects in the shared store are not automatically copied and stored locally at the unit.

15. The computer-readable medium containing a program of claim 14 wherein the shared store display indicates copies of an object at different units in the network.

16. The computer-readable medium with the program of claim 14 wherein the peer-to-peer network comprises a collaborative network.

17. The computer-readable medium containing a program of claim 16 wherein the peer-to-peer network is part of a physical network.

18. The computer-readable medium containing a program of claim 14 wherein the anchors are used to produce the shared store display.

19. The computer-readable medium including a program of claim 18 wherein the anchors include name and location of the object.

20. The computer-readable medium containing a program of claim 18 wherein the anchors include a modification history for the objects.

21. A method comprising:
producing a shared store display at a unit indicating objects in a shared store, the objects in the shared store being available to each of the units in a peer-to-peer network, the shared store display referencing local objects at the unit and remote objects at the other units; and
under user control, reconciling a local object with a remote object referenced in the shared store by deciding how to reconcile conflicts by replacing a local or remote object, or using an application to merge changes appropriately, then removing a local object if desired.

22. The method of claim 21 further comprising, before the reconciliation step, copying the remote object to produce the local object.

23. The method of claim 22 further comprising, after the copying step and before the before the reconciliation step, modifying the local object.

24. The method of claim 21 wherein the peer-to-peer network is a collaborative network.

25. The method of claim 21 wherein the peer-to-peer network run on a physical network.

26. The method of claim 21 wherein anchors are used to produce the shared store display.

27. The method of claim 21 wherein the anchors reference the name and location of the objects.

28. The method of claim 21 wherein the anchors reference a modification history for the objects.

29. A computer-readable medium containing a program which executes the following procedure:
producing a shared store display at a unit indicating objects in a shared store, the objects in the shared store being available to each of the units in a peer-to-peer network, the shared store display referencing local objects at the unit and remote objects at the other units; and
under user control, reconciling a local object with a remote object referenced in the shared store by deciding how to reconcile conflicts by replacing a local or remote object, or using an application to merge changes appropriately, then removing a local object if desired.

30. The computer-readable medium containing a program of claim 29 wherein the procedure includes, before the reconciliation step, copying the remote object to produce the local object.

31. The computer-readable medium containing a program of claim 29 wherein the procedure includes, after the copying step and before the before the reconciliation step, modifying the local object.

32. The computer-readable medium containing a program of claim 29 wherein the shared store display indicates copies of an object at different units in the network.

33. The computer-readable medium with the program of claim 29 wherein the peer-to-peer network comprises a collaborative network.

34. The computer-readable medium containing a program of claim 29 wherein the peer-to-peer network is part of a physical network.

35. The computer-readable medium containing a program of claim 29 wherein anchors are used to produce the shared store display.

36. The computer-readable medium including a program of claim 35 wherein the anchors include name and location of the object.

37. The computer-readable medium containing a program of claim 35 wherein the anchors include a modification history for the objects.
